(19) United States
(12) Patent Application Publication
(10) Pub. No.: US 2002/0042039 A1
(43) Pub. Date: Apr. 11, 2002

(54) Image storage system for dental treatment

(76) Inventors: Suck Joon Kim, Seoul (KR); Jung Hoon Jhang, Young In-City (KR); Jun Hyung Kim, Seoul (KR); Kang Il. Seo, Seoul (KR)

Correspondence Address: CHRISTIE, PARKER & HALE, LLP, 350 WEST COLORADO BOULEVARD, SUITE 500, PASADENA, CA, 91105, US

(21) Appl. No.: 09/967,129

(22) Filed: Sep. 27, 2001

(30) Foreign Application Priority Data
Sep. 29, 2000 (KR) 2000-27419

(51) Int. Cl. A61C 3/00

(52) U.S. Cl. 433/29

(57) ABSTRACT

An image storage system for dental treatment is disclosed. The image storage system has an endoscope having a camera for obtaining a picture of the cavity of a mouth as an analog image signal during a dental treatment, and a lighting unit integrated with the camera into a single body and having an LED with a high luminance. An image signal storage unit converts and stores the image signal from the camera. A microcontroller controls the image signal storage unit to convert and store the image signal. An LCD monitor displays an output image signal from the image signal storage unit visually.

### BACKGROUND OF THE INVENTION

1. Field of the Invention

The present invention relates in general to an image storage system for dental treatment, and more particularly to an image storage system for dental treatment, for storing images of patient's dental condition as image data and observing the image data when a doctor treats the patient in a dentist's office, thus more easily understanding the patient's dental condition.

2. Description of the Prior Art

Generally, when a doctor(or a dentist) examines a patient in a dentist's office, the doctor views the patient's oral cavity, and then treats the patient. In such a treatment process, the doctor explains the patient's dental condition to the patient, and the patient learns his or her dental condition by listening to the doctor's explanation. In this case, the patient cannot view his or her dental condition directly, such that patient cannot precisely understand his or her dental condition.

In order to solve the problem, a doctor takes a picture of the regions of the patient's mouth to be treated, and prints the picture, and then explains the patient's dental condition to the patient. However, such a method is problematic in that the doctor must photograph the regions to be treated for every dental treatment, thus increasing the treatment time and costs, and preventing the doctor from keeping the pictures for a lengthy period of time.

### SUMMARY OF THE INVENTION

Therefore, the present invention has been made in view of the above problem, and it is an object of the present invention to provide an image storage system for dental treatment, for storing images of a patient's oral cavity as image data, such that both a doctor and the patient can easily understand the patient's dental condition.

In accordance with one aspect of the present invention, the above and other objects can be accomplished by the provision of an image storage system for dental treatment, comprising an endoscope having a camera for obtaining a picture of the cavity of a mouth as an analog image signal during a dental treatment, and a lighting unit integrated with the camera into a single body and having an LED with a high luminance; an image signal storage unit for converting and storing the image signal from the camera; a microcontroller for controlling the image signal storage unit to convert and store the image signal; and an LCD monitor for displaying an output image signal from the image signal storage unit visually.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing an image storage system for dental treatment of the preferred embodiment of this invention;

FIG. 2 is a perspective view showing the image storage system for dental treatment of this invention; and

FIG. 3 is a front side view showing an endoscope included in the image storage system of this invention.

### DETAILED DESCRIPTION OF THE PREFERRED EMBODIMENTS

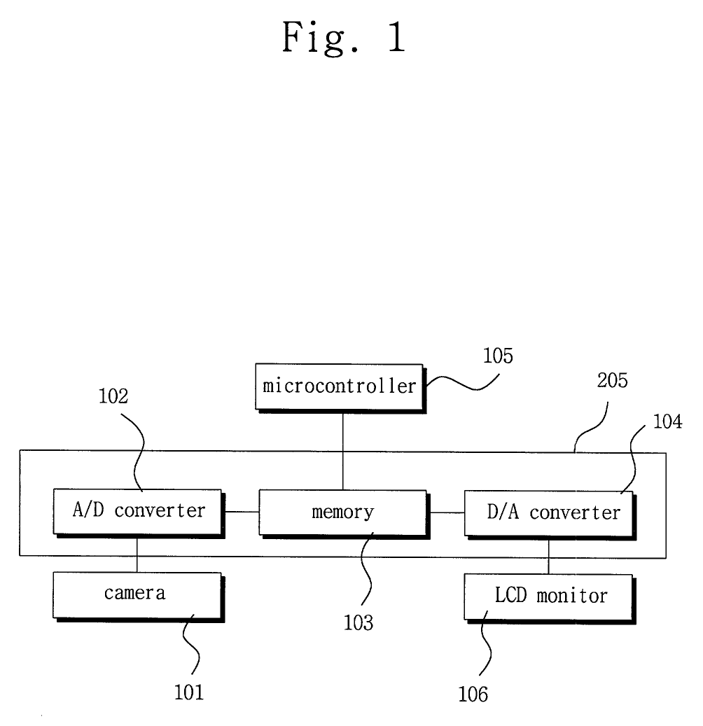

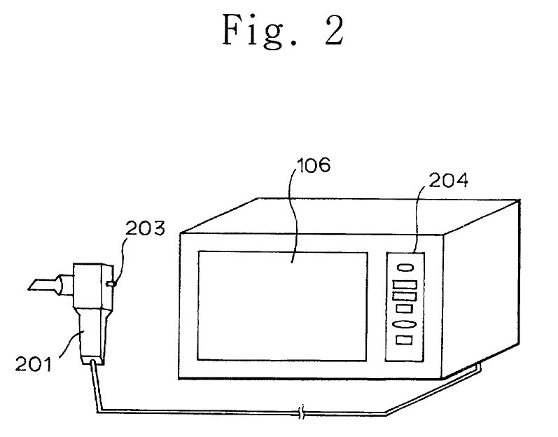

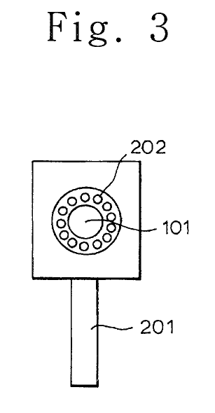

FIG. 1 is a block diagram showing an image storage system for dental treatment of the preferred embodiment of this invention. FIG. 2 is a perspective view showing the image storage system for dental treatment, and FIG. 3 is a front side view showing an endoscope of the image storage system.

Referring to FIGS. 1 to 3, the image storage system for dental treatment comprises an endoscope 201, an image signal storage unit 205, a microcontroller 105, and an LCD (Liquid Crystal Display) monitor 106.

The endoscope 201 includes a camera 101 and a lighting unit 202. The lighting unit 202 has a Light Emitting Diode (LED) with a high luminance to enable the user to easily photograph the dark cavity of the mouth. In other words, the lighting unit 202 of this invention employs the highly luminous LED instead of the conventional structure for transmitting light from a halogen light source through typical optical fiber to the cavity of the mouth. Accordingly, the image storage system of this invention does not require any separate light source, thus preventing the camera from undesirably radiating heats.

Referring to FIG. 1, the image signal storage unit 205 includes an Analog to Digital (A/D) converter 102, a memory 103, and a Digital to Analog (D/A) converter 104. The A/D converter 102 converts an analog image signal from the camera 101 into a digital value. The memory 103 stores the digital value from the A/D converter 102. The D/A converter 104 converts the digital value stored in the memory 103 into an analog value for displaying the image signal on the LCD monitor 106.

The microcontroller 105 controls the A/D converter 102, the memory 103, and the D/A converter 104 so as to convert the image signal into the digital value, store the digital value, and reproduce the digital value as an analog signal without an external operation, respectively.

The LCD monitor 106 displays the analog signal from the D/A converter 104 visually, thus allowing the patient and the doctor to view the affected or treated regions of the patient's mouth at the same time.

The image storage system for dental treatment of this invention is installed on an operating table(or a support structure), a shelf or a dentist's chair, such that it is freely adjusted in its height to allow a doctor to easily photograph the cavity of a patient's mouth. Further, when a doctor finds a region to be photographed in the cavity of a patient's mouth, the doctor promptly photographs the target region using the image storing switch 203. At this time, both the patient and the doctor can view the photographs of the target regions while magnifying the images or repeatedly displaying the images as a treatment progresses, using the operation unit 204.

Further, the image storage system may help the patient understand his or her condition. In this case, the photographs can be conveniently used as information and data to be analyzed to determine the proper course of dental treatment. Further, using the image storage system, the doctor compares images obtained before and after the dental treatment, and so the doctor can easily evaluate the success of the treatment. Moreover, the present invention may employ a detachable endoscope. In such a case, the detachable endoscope can be separated from the image storage system, and effectively utilized for another application, in addition to the dental treatment, and so the system is maximized in its utility.

As apparent from the above description, the present invention provides an image storage system having a camera, which allows a doctor to obtain, store, and reproduce images of the dental condition of a patient before and after a dental treatment, thus allowing the patient to precisely understand his or her state, and enabling the doctor to utilize the photographs as data for analyzing a patient's condition, and determining and prescribing an appropriate course of dental treatment. Further, the present invention realizes clearer image quality by installing an LED with a high luminance in the endoscope, without a separate light source, thereby maximizing its utility.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An image storage system for dental treatment, comprising:
an endoscope having a camera for obtaining a picture of the cavity of a mouth as an analog image signal during a dental treatment, and a lighting unit integrated with the camera into a single body and having an LED with a high luminance;
an image signal storage unit for converting and storing the image signal from the camera;
a microcontroller for controlling the image signal storage unit to convert and store the image signal; and
an LCD monitor for displaying an output image signal from the image signal storage unit visually.

2. The image storage system as set forth in claim 1, wherein the image signal storage unit includes:
an A/D converter for converting the analog image signal from the camera into a digital value;
a memory for storing the digital value from the A/D converter; and
a D/A converter for converting the digital value from the memory into an analog value.

3. The image storage system as set forth in claim 1, wherein the endoscope, the image signal storage unit and the LCD monitor are integrated into a single body to be installed on an operating table.
